(19) United States
(12) Patent Application Publication
(10) Pub. No.: US 2001/0026721 A1
(43) Pub. Date: Oct. 4, 2001

(54) Method and apparatus for adjusting print positions of dot line printer

(76) Inventor: Hideaki Ozawa, Tokyo (JP)

Correspondence Address: McGinn & Gibb, PLLC, 8321 Old Courthouse Road, Suite 200, Vienna, VA, 22182-3817, US

(21) Appl. No.: 09/822,199

(22) Filed: Apr. 2, 2001

(30) Foreign Application Priority Data
Apr. 3, 2000 (JP) 101446/2000

(51) Int. Cl. B41J 21/16

(52) U.S. Cl. 400/279

(57) ABSTRACT

A control circuit generates two sorts of printing timing signals on the basis of the position of the printing mechanism module detected by a detector, and sends the generated signals to respective drive circuits. Herein, the printing mechanism module is configured of two printing element assemblies each of which includes a plurality of printing elements, and both of which are mechanically coupled. The two drive circuits taking charge of the two printing element assemblies send printing input signals to the respective printing elements which are to be driven according to the two sorts of printing timing signals received by the drive circuits. The relative positions between the print dots of the two printing element assemblies can be adjusted for each direction of printing on a sheet by changing the difference between the times of the two sorts of printing timing signals.

### BACKGROUND OF THE INVENTION

The present invention relates to a method and an apparatus for adjustng the print positions of a dot line printer.

A method and an apparatus for adjusting the print positions of a dot line printer in the prior art will be described in detail with reference to the drawings.

FIG. 1 is a perspective view for explaining a first prior-art example (refer to, for example, Japanese Unexamined Patent Publication (JP-A) No. 244282/1996).

The dot line printer is constructed of a hammer bank 2 in which a large number of printing hammers 1 are arrayed in one row, a shuttle mechanism 8 which vibrates the hammer bank 2 laterally at a predetermined amplitude, a sheet feed mechanism 12, and so forth.

In the shuffle mechanism 8, the hammer bank 2 supported by right and left parallel flat springs 7 is connected to an eccentric cam 6 of a shuttle drive motor 5 through a connecting rod 4. When the shuttle drive motor 5 is rotated, the hammer bank 2 is vibrated in an approximate sinusoidal wave rightwards and leftwards. The sheet feed mechanism 12 is constituted by a platen 9 for transporting a printing sheet 13, and a sheet feed motor 11 for driving the platen 9 through a belt 10, thereby to transport the sheet 13 every dot line very exactly. While the hammer bank 2 is vibrated, the respective printing hammers 1 are operated to print dots at predetermined intervals, so that one row of dots is formed by the one-way operation (forward printing) Subsequently, when the hammer bank 2 is turned back (for reverse printing), the sheet 13 is transported the interval of one dot line, and the next dot line is printed. Further, the sheet 13 is transported one dot line immediately before forward printing. Characters are printed by repeating such operations. Incidentally, numeral 3 designates an inking ribbon.

FIG. 2 is a waveform diagram showing the printing timing signals of the prior-art dot line printer. A hammer bank leftmost-end signal 30 and a hammer bank rightmost-end signal 31 indicating the arrivals of the hammer bank 2 at the leftmost end and rightmost end thereof start a forward printing timing signal 32 for executing the forward printing and a reverse printing timing signal 33 for executing the reverse printing, respectively. Both the forward printing timing signal 32 and the reverse printing timing signal 33 are generated substantially at the time when hammer bank speed 36 is a set value. Since the printing is performed by reciprocally moving the hammer bank 2 by means of the shuttle mechanism 8, the printing of the identical printing hammer 1 must not allow a misalignment or shear between the lateral printing of the forward printing mode and that of the reverse printing mode. It is difficult, however, to avoid the lateral print shear of the identical printing hammer 1 between the forward and reverse printing modes merely by keeping the mechanical balance of the shuttle mechanism 8 which reciprocally moves the hammer bank 2. In the pror-art dot line printer, therefore, a reverse printing timing signal 35 as shown in FIG. 2 is generated after a delay of a time period after the transmission of the pulse of the hammer bank rightmost-end signal 31. The printing of the identical printing hammer 1 can be freed from the lateral print shear between in the forward printing mode and in the reverse printing mode by adjusting the time period t.

Besides, the line feed of the dot line of the sheet 13 is started by the final pulse of both the forward printing timing signal 34 and the reverse printing timing signal 35.

With the method for adjusting the print positions of the dot line printer in the first prior-art example, it is intended to compensate for the lateral print shear of the identical printing hammer 1 by shifting the reverse printing timing signal 35 in the reciprocal motion. On the other hand, the sheet line feed operation is started by the final pulse of both the forward printing timing signal 34 and the reverse printing timing signal 35, so that decrease or increase in the time period of the line feed is incurred. Accordingly, the sheet 13 does not cease moving before the start of the printing as shown by the sheet line feed speed 37 in FIG. 2, and hence, print dot positions become disordered to degrade print quality.

FIG. 3 is a waveform diagram showing a second prior-art example, Here in the second prior-art example, a dot line printer itself is supposed the same as shown in FIG. 1. A hammer bank leftmost-end signal 20 and a hammer bank rightmost-end signal 21 indicating the arrivals of the hammer bank 2 at the leftmost end and rightmost end thereof start a forward printing timing signal 22 for executing the forward printing and a reverse printing timing signal 23 for executing the reverse printing, respectively. Both the forward printing timing signal 22 and the reverse printing timing signal 23 are substantially generated at times when hammer bank speed 26 is a predetermined value.

Since the printing is performed by reciprocally moving the hammer bank 2 by means of the shuttle mechanism 8, in the printing of the identical printing hammer 1 shear or misalignment between the lateral print of the forward printing mode and that of the reverse printing mode is not allowable. It is difficult, however, to avoid the lateral print shear of the identical printing hammer 1 between in the forward printing mode and in the reverse printing mode merely by keeping the mechanical balance of the shuttle mechanism 8 which reciprocally moves the hammer bank 2.

Therefore, a forward printing timing signal 24 as shown in FIG. 3 is generated after a delay of a time period ti following generation of the pulse of the hammer bank leftmost-end signal 20.

Subsequently, a reverse printing timing signal 25 as shown in FIG. 3 is generated after a delay of a time period t₂ following generation of the pulse of the hammer bank rightmost-end signal 21. The printing of the identical printing hammer 1 can be freed from the lateral print shear between the forward printing mode and the reverse printing mode by adjusting the time periods t₁ and t₂.

The line feed of the dot line of the sheet 13 is started by the final pulse of both the forward printing timing signal 24 and the reverse printing timing signal 25. In this embodiment, the forward printing timing signal 24 and the reverse printing timing signal 25 are both adjusted by the predetermined adjustment time periods t₁ and t₂ relatively to the hammer bank leftmost-end signal 20 and the hammer bank rightmost-end signal 21, respectively, As shown by a sheet line feed speed 27 in FIG. 3, therefore, decrease or increase in the time period of the line feed is not incurred, to eliminate the drawback that the sheet 13 does not come to a stop before the start of the printing, causing print dot positions to become disordered to degrade print quality. Further, the adjustment can be facilitated more by equalizing the adjustment time periods t₁ and t₂.

With the method and apparatus for adjusting the print positions of the dot line printer in the second prior-art example, only one printing element assembly is concerned, and hence, the print shear can be avoided by adjusting the forward and reverse printing timing signals. However, in a case where a dot line printer includes a plurality of printing element assemblies and where the relative positions of the printing element assemblies in the extending direction thereof (in the line direction of a printing sheet) are not exactly in alignment, the relative positions of the print dots of the printing element assemblies cannot be corrected merely by the pair of printing timing signals in the forward and reverse modes.

Further, even in case of a known dot line printer whose printing mechanism module has a plurality of printing element assemblies, only one drive circuit is included, and only one printing timing signal is generated by a control circuit. Besides, while the printing element assemblies are mechanically coupled, the relative positions of these printing element assemblies in the extending direction thereof sometimes fail to meet designed values on account of discrepancy in the dimensions of the individual printing element assemblies. On this occasion, since only one printing timing signal is generated, the positions of installed printing elements are directly reflected on print dots formed, and the relative positions between the print dots in the extending direction (in the line direction of a printing sheet) fall outside designed values.

In a case where the relative positions between the print dots in the line direction misalign by a large amount due to the plurality of printing element assemblies, these assemblies must be mechanically regulated, and the magnitude of the regulation is a level of several tens μm. Accordingly, there have hitherto been the disadvantages that the regulation is difficult and that the number of the stages of the adjusting work enlarges.

### SUMMARY OF THE INVENTION

It is therefore an object of the present invention to provide a method and an apparatus for adjusting the print positions of a dot line printer according to which the relative positions between print dots in the line direction of a printing sheet can be brought to appropriate relative positions without performing any mechanical regulation.

Another object of the present invention to provide a method and an apparatus for adjusting the print positions of a dot line printer according to which the number of the stages of adjusting work is small.

According to the present invention, in a dot line printer having a printing mechanism module which includes a plurality of printing element assemblies each having at least one printing element and which are mechanically coupled, and there is provided a method for adjusting print positions of the dot line printer characterized the adjustment steps of assigning drive circuits to the respective printing element assemblies, and generating a plurality of printing timing signals and individually sending them to said respective printing element assemblies by means of a control circuit, thereby to compensate a misalignment of relative positions between print dots of the printing element assemblies in opposing directions of printing, the misalignment being attendant upon a misalignment of relative positions between the printing element assemblies in opposing line directions.

Also, according to the present invention, in a dot line printer having a printing mechanism module which includes a plurality of printing element assemblies each having at least one printing element and which are mechanically coupled, there is provided an apparatus for adjusting print positions of the dot line printer, characterized by adjustment means for assigning drive circuits to the respective printing element assemblies, and generating a plurality of printing timing signals and individually sending them to the respective printing element assemblies by means of a control circuit, thereby to compensate a misalignment of relative positions between print dots of the printing element assemblies in opposing directions of printing, the misalignment being attendant upon a misalignment of relative positions between the printing element assemblies in opposing line directions.

Further, according to the present invention, in a dot line printer having a printing mechanism module which includes a plurality of printing element assemblies each having at least one printing element and which are mechanically coupled, there is provided an apparatus for adjusting print positions of the dot fine printer, characterized by comprising a detector which detects a position of the printing mechanism module, and a control circuit which generates two sorts of printing timing signals on the basis of an output signal of the detector.

### BRIEF DESCRIPTION OF THE DRAWINGS:

FIG. 1 is a perspective view for explaining a method and an apparatus for adjusting the print positions of a dot line printer in a first prior-art example;

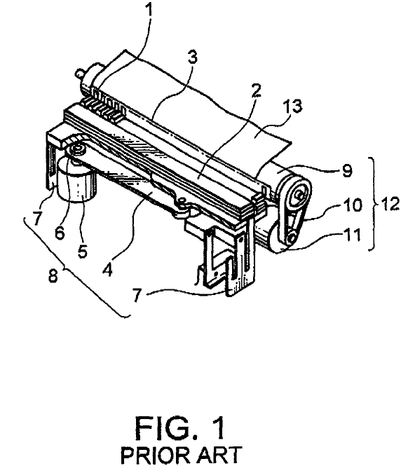

FIG. 2 is a waveform diagram for explaining the operation of the method and apparatus shown in FIG. 1;

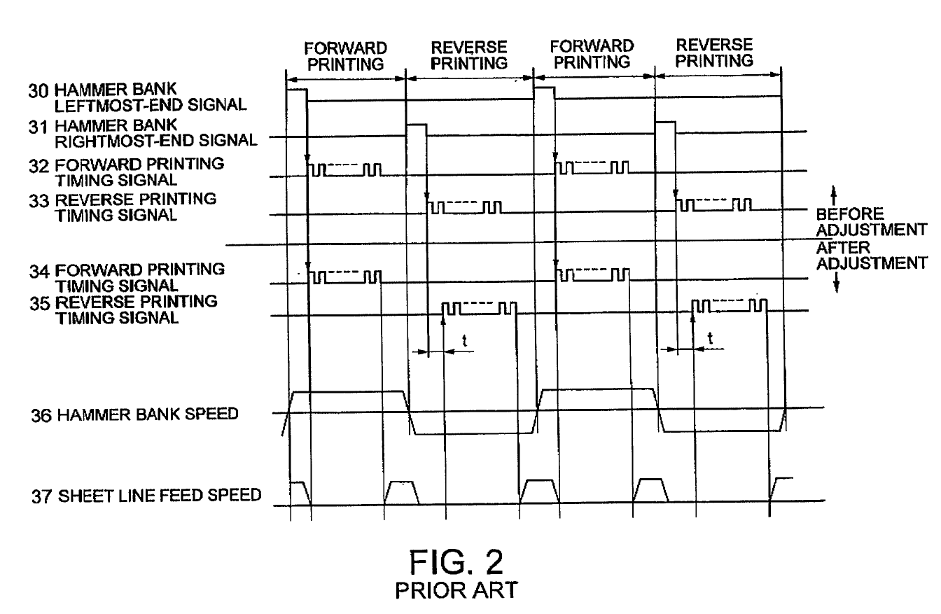

FIG. 3 is a waveform diagram for explaining the operation of a method and an apparatus for adjusting the print positions of a dot line printer in a second prior-art example;

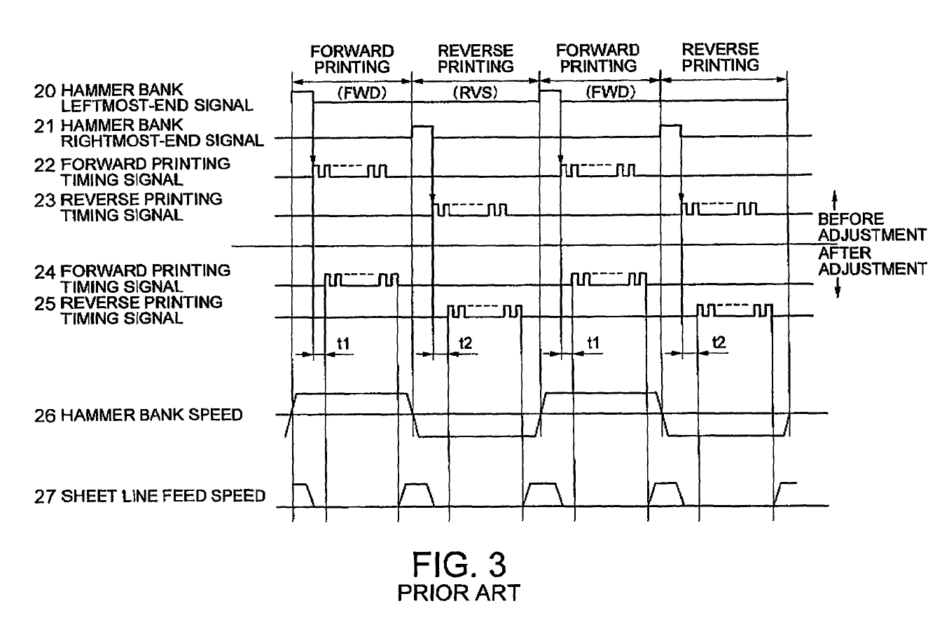

FIG. 4 is a block diagram showing a method and an apparatus for adjusting the print positions of a dot line printer in an embodiment of the present invention; and

FIG. 5 is a waveform diagram for explaining the operation of the method and apparatus shown in FIG. 4.

### DESCRIPTION OF THE PREFERRED EMBODIMENT;

In a dot line printer having a printing mechanism module which includes a plurality of printing element assemblies, the present invention is intended to avoid that misalignment of print dots in the line direction of a printing sheet which is ascribable to the misalignment of the relative positions of the printing element assemblies mechanically combined, and it consists of separately disposing drive circuits for the respective printing element assemblies and individually sending printing timing signals from a control circuit to the respective assemblies, thereby to adjust the print dot positions of the printing element assemblies.

Now, an embodiment of the present invention will be described in detail with reference to the drawings.

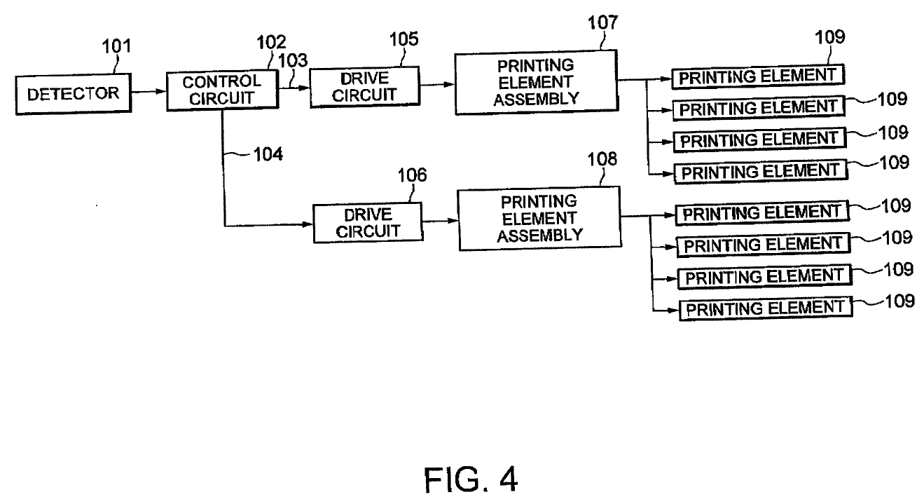

FIG. 4 is a block diagram showing one embodiment of the present invention. The embodiment concerns a dot line printer which includes, for example, two printing element assemblies 107, 108. A detector 101 detects the position of a printing mechanism module. A control circuit 102 generates two sorts of printing timing signals 103, 104 on the basis of the detected position, and the generated signals 103, 104 are respectively sent to drive circuits 105, 106. Herein, the printing mechanism module is configured of the two printing element assemblies 107 and 108 each of which has a plurality of printing elements 109, and both of which are mechanically coupled. The drive circuits 105, 106 taking charge of the printing element assemblies 107, 108 respectively supply the printing elements 109 to-be-driven with printing input signals on the basis of the received printing timing signals 103, 104, respectively. Accordingly, the relative positions between the print dots of the printing element assemblies 107, 108 can be adjusted in the line direction of a printing sheet by changing the difference between the times of the printing timing signals 103, 104.

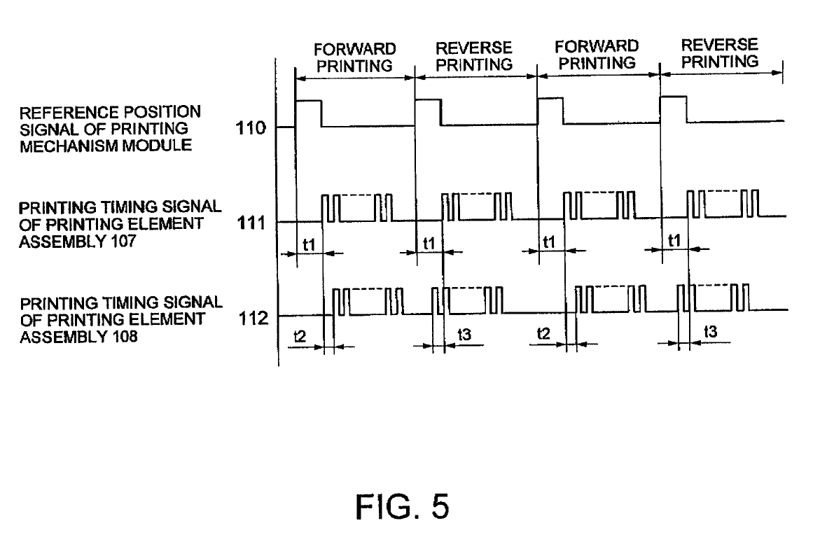

FIG. 5 is a waveform diagram showing the printing timing signals for explaining the operation of the embodiment of the present invention. When the printing mechanism module has arrived at a predetermined position during its horizontal reciprocating rectilinear motion due to a shuttle mechanism module, the sensor 101 detects the arrival and generates a reference position signal 110. The printing timing signal 111 of the printing element assembly 107 is generated after a predetermined time period t₁ on the basis of the reference position signal 110.

Subsequently, in a case where the dot position of the printing element assembly 108 is to be shifted in, for example, a forward printing direction relatively to that of the printing element assembly 107, the printing timing signal 112 of the printing element assembly 108 is generated with the delay of a time period t₂ in the forward printing mode thereof. The time period t₂ is determined from the moving speed and dot pitch deviation amount of the printing mechanism module.

In the reverse printing mode of the printing element assembly 108, the generation of the printing timing signal 112 is advanced a time period t₃ equal to the time period t₂, relatively to that of the printing timing signal 111 contrariwise to the operating aspect in the forward printing mode. The print dot positions of the printing element assembly 108 can be adjusted as required by controlling the time periods t₂, t₃.

With the method and apparatus of the present invention for adjusting the print positions of a dot line printer, the optimum print positions can be attained by adding the procedure or means for adjusting the relative positions between the printed dots in lines facing each other, without performing any mechanical regulation. Moreover, the number of the stages of an adjusting work can be decreased.

What is claimed is:

1. In a dot line printer having a printing mechanism module which includes a plurality of printing element assemblies having at least one printing element, and which are mechanically coupled; a method for adjusting print positions of the dot line printer, comprising the adjustment steps of assigning drive circuits to the respective printing element assemblies, and generating a plurality of printing timing signals and individually sending them to said respective printing element assemblies by means of a control circuit, thereby to compensate a misalignment of relative positions between print dots of said printing element assemblies in opposing directions of printing, the misalignment being attendant upon a misalignment of relative positions between said printing element assemblies in opposing line directions.

2. A method for adjusting print positions of the dot line printer as claimed in claim 1, wherein said adjustment step adjusts the relative positions between the print dots of said printing element assemblies for each line direction of printing by changing the difference between the timing of said printing timing signals.

3. In a dot line printer having a printing mechanism module which includes a plurality of printing element assemblies each having at least one printing element, and which are mechanically coupled; an apparatus for adjusting print positions of the dot line printer, comprising adjustment means for assigning drive circuits to the respective printing element assemblies, and generating a plurality of printing timing signals and individually sending them to said respective printing element assemblies by means of a control circuit, thereby to compensate a misalignment of relative positions between print dots of said printing element assemblies in opposing directions of printing, the misalignment being attendant upon a misalignment of relative positions between said printing element assemblies in opposing line directions.

4. In a dot line printer having a printing mechanism module which includes a plurality of printing element assemblies each having at least one printing element, and which are mechanically coupled; an apparatus for adjusting print positions of the dot line printer, comprising a detector which detects a position of the printing mechanism module, and a control circuit which generates two sorts of printing timing signals on the basis of an output signal of said detector.

5. An apparatus for adjusting print positions of the dot line printer as claimed in claim 4, wherein each of said printing element assemblies in which said printing mechanism modules having at least two printing elements are mechanically coupled.

6. An apparatus for adjusting print positions of the dot line printer as claimed in claim 4, further comprising drive circuits which take charge of the respective printing element assemblies, and which send printing input signals to the printing elements that are to be driven according to the printing timing signals received by said drive circuits.
